(19) United States
(12) Patent Application Publication
(10) Pub. No.: US 2026/0259018 A1
(43) Pub. Date: Sep. 3, 2026

(54) RADIATIVE COOLING DEVICE USING AT LEAST ONE REINFORCEMENT LAYER FOR RADIATIVE COOLING

(71) Applicant: Korea University Research and Business Foundation, Seoul (KR)

(72) Inventors: Heon LEE, Seoul (KR); Dong Woo CHAE, Seoul (KR)

(73) Assignee: Korea University Research and Business Foundation, Seoul (KR)

(21) Appl. No.: 18/833,314

(22) PCT Filed: Feb. 15, 2024
(86) PCT No.: PCT/KR2024/095148

§ 371 Date: Jul. 25, 2024

(30) Foreign Application Priority Data
Feb. 20, 2023 (KR) 10-2023-0022277

(51) Int. Cl. F28F 13/18

(52) U.S. Cl. CPC F28F 13/185; F28F 2225/00; F28F 2245/06

(57) ABSTRACT

Disclosed is a radiative cooling device including at least one reinforcement layer for radiative cooling. The radiative cooling device according to an embodiment of the present invention includes a radiative cooling layer configured to scatter and reflect incident sunlight to achieve radiative cooling reflectivity, a first reinforcement layer configured to increase the durability of the radiative cooling layer, configured to increase the radiative cooling emissivity, and configured to maintain the radiative cooling reflectivity, and a second reinforcement layer formed on the first reinforcement layer or the radiative cooling layer, formed of at least one fluorosilane-based material, and configured to increase a contact angle for a liquid material in contact with a surface.

### TECHNICAL FIELD

The present invention relates to a radiative cooling device including at least one reinforcement layer for radiative cooling, and more particularly a technology for preserving the long-term optical characteristics of radiative cooling performance in a radiative cooling device by forming at least one reinforcement layer for radiative cooling on a radiative cooling material to improve durability and prevent contamination.

### BACKGROUND ART

Heat transfer in radiative cooling occurs through a spontaneous, energy-free process called infrared radiation (emission).

The heat energy of a cooling body is radiated out of the Earth's atmosphere, not into the surrounding environment of the cooling body. Therefore, it is a new technology that can be cooled to a temperature lower than the ambient temperature without consuming energy.

That is, heat exchange by radiation from a cooling body to the outside of the Earth's atmosphere is accomplished by thermal radiation (infrared radiation), a spontaneous process that does not require energy.

The key to zero-energy radiative cooling is to reflect incident sunlight as much as possible without absorbing it.

Also, the key to zero-energy radiative cooling is to radiate as much of one's thermal energy to the outside as possible. The emission of thermal energy can be realized through the absorption and emission of long-wavelength infrared rays of 8 μm to 13 μm which is a wavelength range corresponding to the sky window.

For example, during a sunny day, the internal temperature of a black car that absorbs light easily rises, but in the case of a white car that reflects light rather than absorbs it, the temperature rises relatively less.

The surface of a white car, which does not absorb sunlight or reflect sunlight well, reflects light in the UV-visible-near-infrared wavelength range, i.e., incident sunlight, as much as possible to minimize the influx of thermal energy due to the absorption of sunlight.

At the same time, if 100% of sunlight is not reflected and more thermal energy than the incoming thermal energy is discharged to the outside through the infrared radiation of the sky window, which is not absorbed by the earth's atmosphere, the car's temperature can be cooled to lower than the surrounding temperature.

In addition to nitrogen, oxygen, and argon, the Earth's atmosphere contains small amounts of water vapor and carbon dioxide. Water vapor and carbon dioxide gas absorb some of the long-wavelength infrared rays that the Earth radiates to the outside, suppressing radiation to the outside.

A representative example is the “greenhouse effect.” As the concentration of carbon dioxide in the Earth's atmosphere increases, the emission of long-wave infrared rays emitted by the Earth into space is interrupted, preventing heat from being discharged from the Earth to space and causing the Earth's temperature to rise.

However, long-wavelength infrared rays from the atmospheric window are not absorbed by the Earth's atmosphere and are easily radiated out of the Earth's atmosphere.

Various types of radiative cooling devices have been studied, and initially, a radiative cooling device in the form of a multilayer thin film deposited on a substrate was proposed.

A silver (Ag) thin film is deposited on a substrate to reflect incident sunlight, and a multilayer thin film of materials that are transparent to incident sunlight and can absorb long-wavelength infrared rays well and radiate them to the outside is laminated on the silver (Ag) thin film, thereby constructing a device.

In addition, a radiative cooling device in the form of a polymer film wherein a silver (Ag) thin film for solar light reflection is deposited on one side of the polymer film and ceramic microparticles for long-wavelength infrared radiation are dispersed inside the film was proposed.

Both of these devices used specular reflection which reflects incident sunlight like a mirror by using a metal thin film such as Ag to reflect incident sunlight.

By using white scattering reflection that is white without a mirror-like appearance by scattering and reflecting light for all wavelengths of incident sunlight instead of specular reflection, radiative cooling can also be performed by reflecting incident sunlight rather than absorbing it.

In particular, white scattered reflection does not use an expensive silver (Ag) thin film, so manufacturing costs are lower. In addition, since there is no deterioration in product performance due to the deterioration of the silver (Ag) thin film, the product lifespan is extended, making it more suitable for manufacturing a radiative cooling device.

Most radiative cooling devices (materials) use metal materials such as silver or aluminum, which gives them a silvery color or a white color because they reflect light through scattering between particles and air.

Because a silver radiative cooling device contains silver or aluminum, it is not free from oxidation problems in its long-term use.

If a radiative cooling device is exposed at the top, there is a problem in its long-term use that the radiative cooling device may become contaminated and peel off due to impregnation with bird droppings, contaminants, UV, moisture, etc., preventing it from providing sufficient radiative cooling ability.

A radiative cooling device can achieve a performance of 100 W/m² during the day, but if durability deteriorates due to peeling, contamination, etc., sufficient cooling performance cannot be achieved in the long term.

### DISCLOSURE

### Technical Problem

Therefore, the present invention has been made in view of the above problems, and it is one object of the present invention to preserve the long-term optical characteristics of radiative cooling performance in a radiative cooling device by forming at least one reinforcement layer for radiative cooling on a radiative cooling material to improve durability and prevent contamination.

It is another object of the present invention to provide a reinforcement layer for radiative cooling to increase the water contact angle and to reduce the degree of contamination from contaminants as water bounces, thereby capable of preserving long-term optical characteristics.

It is still another object of the present invention to improve surface roughness while maintaining radiative cooling performance without deteriorating radiative cooling performance and while improving durability and anti-fouling properties by introducing the reinforcement layer for radiative cooling.

It is yet another object of the present invention to improve the durability and contamination prevention properties of a radiative cooling device including radiative cooling paint which can be installed outdoors in data centers, communication equipment, relay facilities, etc. and can be used as a method to solve problems caused by temperature increase of equipment due to internal heat.

### Technical Solution

In accordance with an aspect of the present invention, the above and other objects can be accomplished by the provision of a radiative cooling device, including: a radiative cooling layer formed of a first mixture prepared by mixing at least one particle of pores, ceramic particles and polymer particles with a binder, formed on a substrate, configured to absorb and emit long-wavelength infrared rays in a range of 8 μm to 13 μm based on the first mixture to achieve radiative cooling emissivity, and configured to scatter and reflect incident sunlight in a range of 0.3 μm to 2.5 μm to achieve radiative cooling reflectivity; a first reinforcement layer formed on the radiative cooling layer, formed of a second mixture of ceramic particles and a binder, configured to prevent mass loss due to external exposure or friction based on the second mixture to increase the durability of the radiative cooling layer, configured to increase the radiative cooling emissivity, and configured to maintain the radiative cooling reflectivity; and a second reinforcement layer formed on the first reinforcement layer or the radiative cooling layer, formed of at least one fluorosilane-based material, and configured to increase a contact angle for a liquid material in contact with a surface.

The radiative cooling layer may absorb and emit the long-wavelength infrared rays, supplement absorption and emission of long-wavelength infrared rays of the binder to increase emissivity in the long-wavelength infrared ray range of 8 μm to 13 μm, and additionally scatter and reflect the incident sunlight based on a difference in refractive indices of the binder and the pores.

The ceramic particles included in the first mixture may include at least one of TiO₂, Al₂O₃, h-BN, ZrO₂, SiO₂, CaCO₃, CaCO₄, BaSO₄, Y₂O₃, Ta₂O₅, Si₃N₄, BeO, MgHPO₄, ZnO, SiC, AlPO₄, AlN and YSZ, the polymer particles included in the first mixture may include at least one of DiPentaerythritol HexaAcrylate (DPHA), PolyDiMethylSiloane (PDMS), Ethylene Tetra Fluoro Ethylene (ETFE), PUA, PolyVinyliDene Fluoride (PVDF), PolyChloroTriFluoroEthylene (PCTFE), PolyEthylene Terephthalate (PET), PolyCarbonate (PC), PolyStyrene (PS) and polyethylene oxide, and the binder included in the first mixture may include at least one of DPHA, PDMS, ETFE, PUA, PVDF, PCTFE, PET, PC, PS, polyethylene oxide, a polyester-based polymer, a polyurethane-based polymer, an acrylic polymer and an alkyd-based polymer.

The ceramic particles included in the second mixture may include at least one of TiO₂, Al₂O₃, h-BN, ZrO₂, SiO₂, CaCO₃, CaCO₄, BaSO₄, Y₂O₃, Ta₂O₅, Si₃N₄, BeO, MgHPO₄, ZnO, SiC, AlPO₄, AlN and YSZ, and the binder included in the second mixture may include at least one of DPHA, PDMS, ETFE, PUA, PVDF, PCTFE, PET, PC, PS, polyethylene oxide, a polyester-based polymer, a polyurethane-based polymer, an acrylic polymer and an alkyd-based polymer.

A thickness of the first reinforcement layer may be formed in a ratio of 70% or less compared to a thickness of the radiative cooling layer.

The first reinforcement layer may be formed by applying a solution, prepared by mixing the second mixture with a solvent, in one coating method of spin coating, bar coating, spray coating, doctor blading, blade coating and dipping.

The fluorosilane-based material may include at least one of 1H,1H,2H,2H-(Perfluorooctyltriethoxysilane) (PFOES) and Heptadecafluoro-1,1,2,2-tetrahydrodecyl) trichlorosilane (HDFS).

The second reinforcement layer may be formed by applying a solution, prepared by dispersing the fluorosilane-based material in a solvent, in one coating method of spin coating, bar coating, spray coating, doctor blading, blade coating and dipping.

The second reinforcement layer may increase the contact angle from 90 degrees to 120 degrees or more, maintain the increased 120 degrees for a predetermined time, achieve hydrophobicity based on the increased 120 degrees, and maintain the achieved radiative cooling emissivity and the achieved radiative cooling.

According to an embodiment of the present invention, the radiative cooling layer may further include a color implementation layer for implementing a color according to a type of color paint formed thereon.

### Advantageous Effects

The present invention can preserve the long-term optical characteristics of radiative cooling performance in a radiative cooling device by forming at least one reinforcement layer for radiative cooling on a radiative cooling material to improve durability and prevent contamination.

The present invention provides a reinforcement layer for radiative cooling to increase the water contact angle and to reduce the degree of contamination from contaminants as water bounces, thereby capable of preserving long-term optical characteristics.

The present invention can improve surface roughness while maintaining radiative cooling performance without deteriorating radiative cooling performance and while improving durability and anti-fouling properties by introducing the reinforcement layer for radiative cooling.

The present invention can improve the durability and contamination prevention properties of a radiative cooling device including radiative cooling paint which can be installed outdoors in data centers, communication equipment, relay facilities, etc. and can be used as a method to solve problems caused by temperature increase of equipment due to internal heat.

### DESCRIPTION OF DRAWINGS

FIGS. 1 to 2B are drawings for explaining a radiative cooling device including at least one reinforcement layer for radiative cooling according to an embodiment of the present invention.

FIGS. 3A and 3B are drawings for explaining a radiative cooling device including a first reinforcement layer for radiative cooling according to an embodiment of the present invention.

FIGS. 4A to 4D are drawings for explaining the optical characteristics of the radiative cooling device including the first reinforcement layer for radiative cooling according to an embodiment of the present invention.

FIG. 5 is a set of drawings for explaining the surface roughness of the radiative cooling device including the first reinforcement layer for radiative cooling according to an embodiment of the present invention.

FIG. 6 is a drawing for explaining a method of manufacturing a radiative cooling device including a second reinforcement layer for radiative cooling according to an embodiment of the present invention.

FIGS. 7 and 8 are drawings for explaining changes in the water contact angle of the radiative cooling device including the second reinforcement layer for radiative cooling according to an embodiment of the present invention.

FIGS. 9 to 10B are drawings for explaining the optical characteristics of the radiative cooling device including the second reinforcement layer for radiative cooling according to an embodiment of the present invention.

FIG. 11 is a set of drawings for explaining the formation ratios of the reinforcement layer for radiative cooling and radiative cooling layer according to an embodiment of the present invention.

FIGS. 12 and 13 are drawings for explaining the performance of the radiative cooling device dependent upon the formation of the reinforcement layer for radiative cooling according to an embodiment of the present invention.

### BEST MODE

The embodiments will be described in detail herein with reference to the drawings.

However, it should be understood that the present invention is not limited to the embodiments according to the concept of the present invention, but includes changes, equivalents, or alternatives falling within the spirit and scope of the present invention.

In the following description of the present invention, a detailed description of known functions and configurations incorporated herein will be omitted when it may make the subject matter of the present invention unclear.

The terms used in the specification are defined in consideration of functions used in the present invention, and can be changed according to the intent or conventionally used methods of clients, operators, and users. Accordingly, definitions of the terms should be understood on the basis of the entire description of the present specification.

In description of the drawings, like reference numerals may be used for similar elements

The singular expressions in the present specification may encompass plural expressions unless clearly specified otherwise in context.

In this specification, expressions such as “A or B” and “at least one of A and/or B” may include all possible combinations of the items listed together.

Expressions such as “first” and “second” may be used to qualify the elements irrespective of order or importance, and are used to distinguish one element from another and do not limit the elements.

It will be understood that when an element (e.g., first) is referred to as being “connected to” or “coupled to” another element (e.g., second), it may be directly connected or coupled to the other element or an intervening element (e.g., third) may be present.

As used herein, “configured to” may be used interchangeably with, for example, “suitable for”, “ability to”, “changed to”, “made to”, “capable of”, or “designed to” in terms of hardware or software.

In some situations, the expression “device configured to” may mean that the device “may do ~” with other devices or components.

For example, in the sentence “processor configured to perform A, B, and C”, the processor may refer to a general purpose processor (e.g., CPU or application processor) capable of performing corresponding operation by running a dedicated processor (e.g., embedded processor) for performing the corresponding operation, or one or more software programs stored in a memory device.

In addition, the expression “or” means “inclusive or” rather than “exclusive or”.

That is, unless otherwise mentioned or clearly inferred from context, the expression “x uses a or b” means any one of natural inclusive permutations.

Terms, such as “unit” or “module”, etc., should be understood as a unit that processes at least one function or operation and that may be embodied in a hardware manner, a software manner, or a combination of the hardware manner and the software manner.

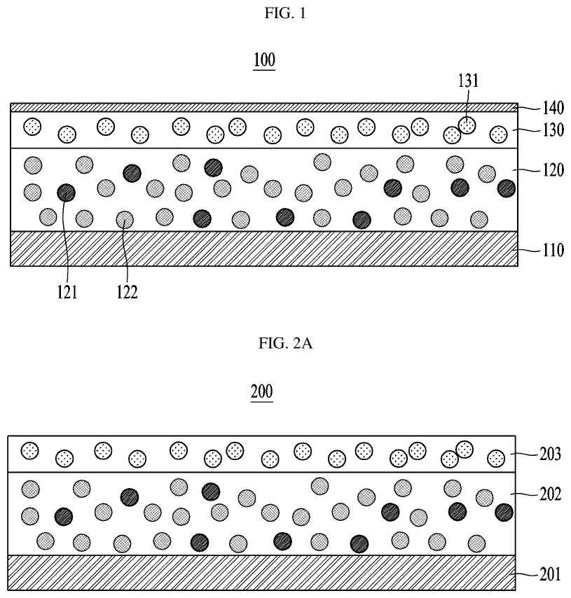

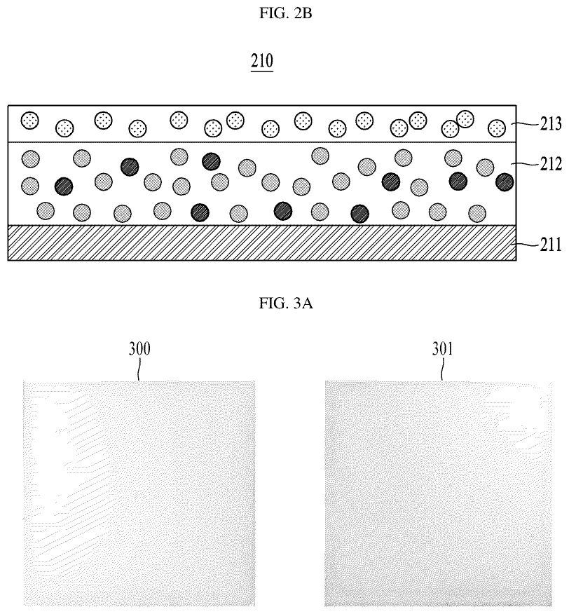

FIGS. 1 to 2B are drawings for explaining a radiative cooling device including at least one reinforcement layer for radiative cooling according to an embodiment of the present invention.

FIG. 1 exemplifies the structure and components of a radiative cooling device using first and second reinforcement layers according to an embodiment of the present invention.

Referring to FIG. 1, a radiative cooling device 100 according to an embodiment of the present invention includes a substrate 110, a radiative cooling layer 120, a first reinforcement layer 130 and a second reinforcement layer 140.

The substrate 110 may be applied to various substrates such as wood, glass, and metal, and may also be applied to a curved or patterned substrate.

The radiative cooling layer 120 is formed on the substrate 110 and secures radiative cooling emissivity by absorbing and emitting long-wavelength infrared rays in a range of 8 μm to 13 μm.

The radiative cooling layer 120 may be formed by applying a first mixture, prepared by mixing at least one particle of pores, ceramic particles and polymer particles with a binder, on the substrate 110.

In addition, the radiative cooling layer 120 secures radiative cooling reflectivity by scattering and reflecting incident sunlight in a range of 0.3 μm to 2.5 μm.

The secured radiative cooling reflectivity is related to the reflection, transmission and absorption of incident sunlight in relation to radiative cooling.

The radiative cooling device 100 according to an embodiment of the present invention secures a reflectance that reflects more than 92% of incident sunlight, secures a transmittance that transmits less than 3.8% of incident sunlight, secures a near-infrared absorptivity that absorbs less than 4.3% of incident sunlight and secures a long-wavelength infrared emissivity that radiates 94% or more of incident sunlight to the atmospheric window.

In a binder of the radiative cooling layer 120, the ceramic particles 121 and the polymer particles 122 are included.

The radiative cooling layer 120 is formed of a mixture prepared by mixing at least one particle of pores (not shown), the ceramic particles 121 and the polymer particles 122 with a binder.

For example, when absorbing and radiating long-wavelength infrared rays based on the ceramic particles 121 and the polymer particles 122, the emissivity of long-wavelength infrared rays in a range of 8 μm to 13 μm may be increased by complementing the absorption and emission of the long-wavelength infrared rays of the binder.

Meanwhile, incident sunlight may be additionally scattered and reflected based on a difference in refractive index between the binder and the pores.

For example, a plurality of pores, ceramic particles 121 and polymer particles 122 may be contained in the binder.

The numbers of the pores, the ceramic particles 121 and the polymer particles 122 may be related to the proportion of each of the materials in the binder.

In addition, incident sunlight is scattered and reflected based on a difference in refractive index between the binder and the ceramic particles 121 and polymer particles 122.

The ceramic particles 121 may include at least one of TiO₂, Al₂O₃, h-BN, ZrO₂, SiO₂, CaCO₃, CaCO₄, BaSO₄, Y₂O₃, Ta₂O₅, Si₃N₄, BeO, MgHPO₄, ZnO, SiC, AlPO₄, AlN and YSZ.

The polymer particles 122 may include at least one of DiPentaerythritol HexaAcrylate (DPHA), PolyDiMethylSiloane (PDMS), Ethylene Tetra Fluoro Ethylene (ETFE), PUA, Poly VinyliDene Fluoride (PVDF), PolyChloroTriFluoroEthylene (PCTFE), PolyEthylene Terephthalate (PET), PolyCarbonate (PC), PolyStyrene (PS) and polyethylene oxide.

The binder may include at least one of DPHA, PDMS, ETFE, PUA, PVDF, PCTFE, PET, PC, PS, polyethylene oxide, a polyester-based polymer, a polyurethane-based polymer, an acrylic polymer and an alkyd-based polymer.

According to an embodiment of the present invention, the first reinforcement layer 130 may be formed on the radiative cooling layer 120, may increase the durability of the radiative cooling layer 120 by preventing mass loss due to external exposure or friction, may increase radiative cooling emissivity, and may maintain radiative cooling reflectivity.

The first reinforcement layer 130 may be made of a second mixture prepared by mixing ceramic particles 131 with a binder, and pores may be included thereinside.

The ceramic particles 131 may include at least one of TiO₂, Al₂O₃, h-BN, ZrO₂, SiO₂, CaCO₃, CaCO₄, BaSO₄, Y₂O₃, Ta₂O₅, Si₃N₄, BeO, MgHPO₄, ZnO, SiC, AlPO₄, AlN and YSZ.

The binder may include at least one of DPHA, PDMS, ETFE, PUA, PVDF, PCTFE, PET, PC, PS, polyethylene oxide, a polyester-based polymer, a polyurethane-based polymer, an acrylic polymer and an alkyd-based polymer.

The first reinforcement layer 130 may be formed by coating with a solution, prepared by mixing the second mixture with a solvent, in one coating method of spin coating, bar coating, spray coating, doctor blading, blade coating and dipping.

The second reinforcement layer 140 is formed on the first reinforcement layer 130 or the radiative cooling layer 120 and increases the contact angle for a liquid substance contacting the surface thereof.

The second reinforcement layer 140 may be formed of at least one fluorosilane-based material. The fluorosilane-based material may include at least one of PFOES (1H,1H,2H,2H-(perfluorooctyltriethoxysilane)) and HDFS((heptadecafluoro-1,1,2,2-tetrahydrodecyl) trichlorosilane).

The second reinforcement layer 140 may be formed of at least one fluorosilane-based material of 1H,1H,2H,2H-(Perfluorooctyltriethoxysilane) (PFOES) and Heptadecafluoro-1,1,2,2-tetrahydrodecyl) trichlorosilane (HDFS).

The second reinforcement layer 140 may be formed by applying a solution, prepared by dispersing at least one fluorosilane-based material in a solvent, in one coating method of spin coating, bar coating, spray coating, doctor blading, blade coating and dipping.

According to an embodiment of the present invention, a color implementation layer that implements colors according to the type of color paint may be further included on the radiative cooling layer 120.

FIG. 2A exemplifies the structure and components of a radiative cooling device including a first reinforcement layer according to an embodiment of the present invention.

Referring to FIG. 2A, a radiative cooling device 200 according to an embodiment of the present invention includes a substrate 201, a radiative cooling layer 202 and a first reinforcement layer 203.

The radiative cooling layer 202 improves the reflectance of incident sunlight through efficient diffuse reflection due to a difference in refractive index.

The first reinforcement layer 203 may be referred to as a radiative cooling top coat layer for improving durability.

The first reinforcement layer 203 may be thinner than the radiative cooling layer 202, and may have a smaller ratio of voids or ceramic particles therein.

The first reinforcement layer 203 may correspond to the first reinforcement layer 130 shown in FIG. 1.

FIG. 2B exemplifies the structure and components of a radiative cooling device including a second reinforcement layer according to an embodiment of the present invention.

Referring to FIG. 2B, a radiative cooling device 210 according to an embodiment of the present invention includes a substrate 211, a radiative cooling layer 212 and a second reinforcement layer 213.

The radiative cooling layer 212 improves the reflectance of incident sunlight through efficient diffuse reflection due to a difference in refractive index.

The second reinforcement layer 213 may be referred to as a radiative cooling top coat layer for enhancing a water contact angle.

The second reinforcement layer 213 may correspond to the second reinforcement layer 140 shown in FIG. 1.

Therefore, the present invention may preserve the long-term optical characteristics of radiative cooling performance in a radiative cooling device by forming at least one reinforcement layer for radiative cooling on a radiative cooling material to improve durability and prevent contamination.

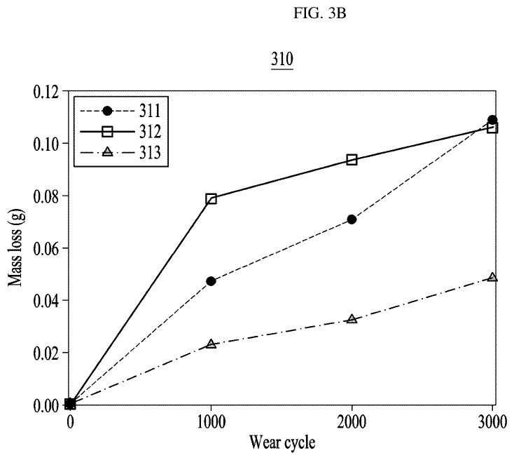

FIGS. 3A and 3B are drawings for explaining a radiative cooling device including a first reinforcement layer for radiative cooling according to an embodiment of the present invention.

FIG. 3A illustrates images of samples for the durability experiment and optical characteristic experiment of the radiative cooling device including the first reinforcement layer for radiative cooling according to an embodiment of the present invention.

FIG. 3A illustrates an image 300 of a first sample and an image 301 of a second sample.

The first sample may be a sample formed by applying a radiative cooling paint solution, prepared using ceramic particles such as Al₂O₃ and h-BN, a polyurethane-based binder, and Propylene Glycol Methyl Ether Acetate (PGMEA), to a thickness of 148 μm on a glass substrate.

The second sample may be a sample formed by applying a radiative cooling paint solution, prepared using ceramic particles, such as Al₂O₃ and h-BN, a polyurethane-based binder and PGMEA, to a thickness of 168 μm on a glass substrate, and then applying a first reinforcement layer for radiative cooling, prepared using ceramic particles, such as Al₂O₃, and a water-based acrylic binder, to a thickness of 52 μm.

The visual difference between image 300 and image 301 is small, so it is difficult to visually distinguish the difference.

FIG. 3B illustrates experimental results of mass loss upon wear of the radiative cooling device including the first reinforcement layer for radiative cooling according to an embodiment of the present invention.

Referring to FIG. 3B, a graph 310 shows mass loss during wear (friction) of a radiative cooling device 311 coated with a commercialized white paint; a radiative cooling device 312 coated with an existing radiative cooling paint; and a radiative cooling device 313 including the first reinforcement layer.

The graph 310 shows that in repeated friction situations, the mass loss of the radiative cooling device 311 is similar to that of the radiative cooling device 312, and the mass loss of the radiative cooling device 313 is reduced.

That is, it can be confirmed that based on mass loss, the durability of the radiative cooling device 313 is improved compared to the radiative cooling device 312.

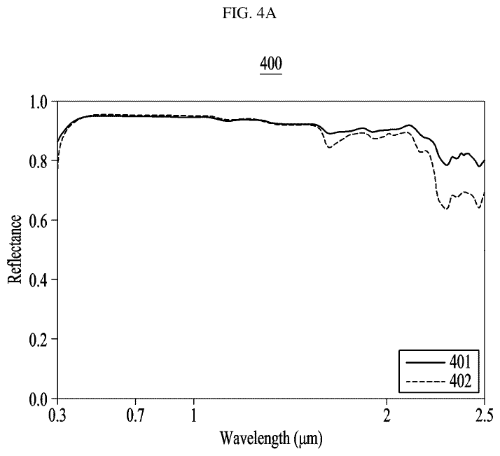

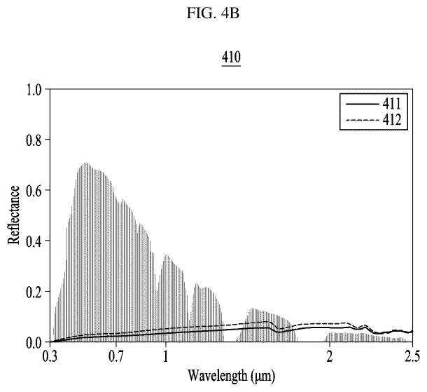

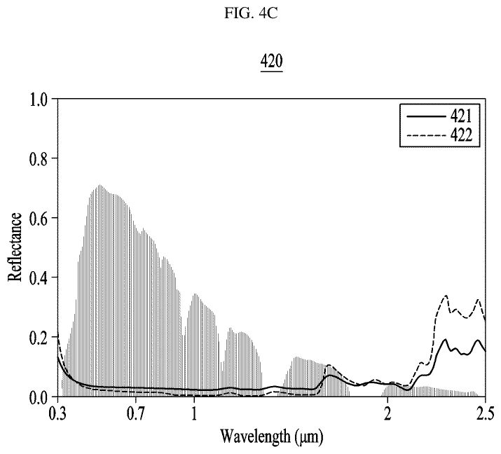

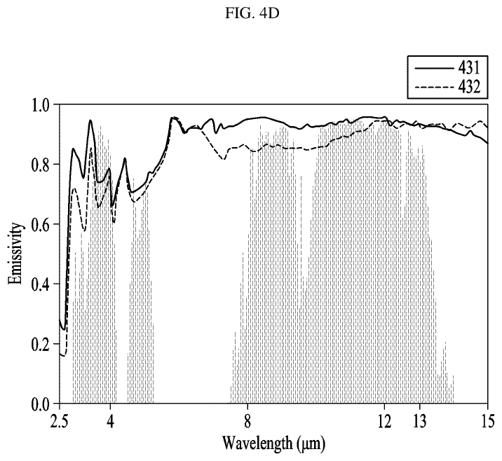

FIGS. 4A to 4D are drawings for explaining the optical characteristics of the radiative cooling device including the first reinforcement layer for radiative cooling according to an embodiment of the present invention.

FIG. 4A illustrates the reflectivity of the radiative cooling device including the first reinforcement layer for radiative cooling according to an embodiment of the present invention.

Referring to FIG. 4A, an indicator line 401 of a graph 400 indicates the first sample of FIG. 3A, and an indicator line 402 thereof indicates the second sample of FIG. 3A.

When comparing the indicator line 401 and the indicator line 402, the reflectance is somewhat lowered, but shows similar results.

FIG. 4B illustrates the transmittance of the radiative cooling device including the first reinforcement layer for radiative cooling according to an embodiment of the present invention.

Referring to FIG. 4B, an indicator line 411 of a graph 410 indicates the first sample of FIG. 3A, and an indicator line 412 thereof indicates the second sample of FIG. 3A.

Comparing the indicator line 411 and the indicator line 412, the transmittance is similar.

FIG. 4C illustrates the absorption of the radiative cooling device including the first reinforcement layer for radiative cooling according to an embodiment of the present invention.

Referring to FIG. 4C, an indicator line 421 of a graph 420 indicates the first sample of FIG. 3A, and an indicator line 422 thereof indicates the second sample of FIG. 3A.

Comparing the indicator line 421 and the indicator line 422, the absorption increases somewhat but shows similar results.

FIG. 4D illustrates the atmospheric window radiance of the radiative cooling device including the first reinforcement layer for radiative cooling according to an embodiment of the present invention.

Referring to FIG. 4D, an indicator line 431 of a graph 430 indicates the first sample of FIG. 3A, and an indicator line 432 thereof indicates the second sample of FIG. 3A.

Comparing the indicator line 431 and the indicator line 432, the atmospheric window radiance increased somewhat.

Referring to the graphs 400 to 430, in the second sample, reflection in the near-infrared region is lowered and absorption is slightly increased as the first reinforcement layer containing a large amount of polymer is introduced, but this makes little difference to the radiative cooling performance.

In addition, it shows that the emissivity increases in the long-wavelength infrared rays region corresponding to the atmospheric window, and the radiative cooling performance parameters for the second sample can be summarized in Table 1 below.

The first sample corresponds to the case where the first reinforcement layer has not been formed, and the second sample corresponds to the case where a first reinforcement layer has been formed.

As shown in Table 1, there was no significant difference in solar reflection between the radiative cooling device containing only the radiative cooling layer based on the radiative cooling paint and the radiative cooling device containing the radiative cooling layer additionally including the first reinforcement layer, and total cooling power increased due to reduced solar absorption and increased sky window radiation.

TABLE 1

| | First reinforcement | First reinforcement |
|---|---|---|
| | layer not formed | layer formed |
| Thickness (μm) before | 148 | 161 |
| formation | | |
| Thickness (μm) after | 148 | 213 |
| formation | | |
| Sunlight reflection (%) | 94.1 | 93.9 |
| Sunlight transmission (%) | 2.3 | 3.5 |
| Sunlight absorption (%) | 3.6 | 2.6 |
| Atmospheric window | 89.0 | 94.2 |
| radiation (%) | | |
| Total cooling power (W/m²) | 95.3 | 109.0 |

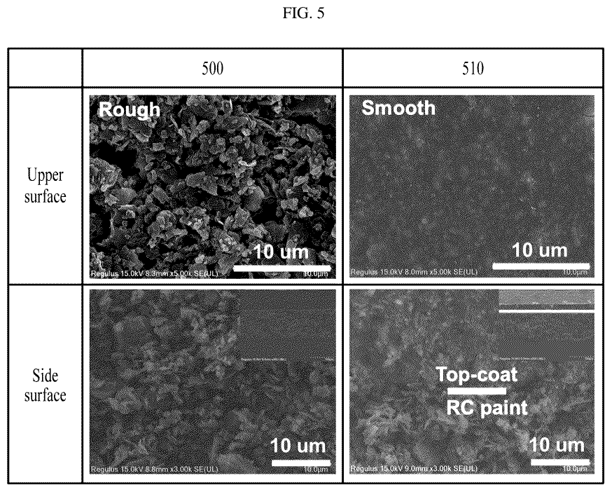

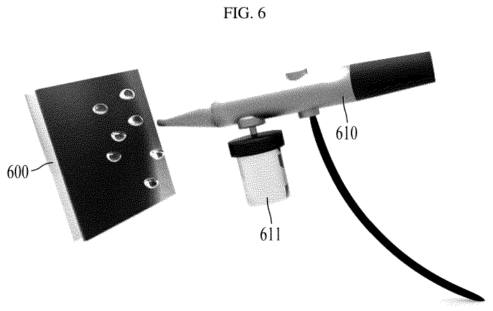

FIG. 5 is a set of drawings for explaining the surface roughness of the radiative cooling device including the first reinforcement layer for radiative cooling according to an embodiment of the present invention.

FIG. 5 illustrates electron microscope images related to the surface roughness of the radiative cooling device including the first reinforcement layer for radiative cooling according to an embodiment of the present invention.

FIG. 5 shows an electron microscope image 500 of the radiative cooling device only including the radiative cooling layer based on a radiative cooling paint; and an electron microscope image 510 of the radiative cooling device including the radiative cooling layer including the first reinforcement layer additionally formed thereon.

An upper surface of the electron microscope image 500 was compared with an upper surface of the electron microscope image 510. This shows that the surface roughness was improved.

When comparing the side surface of the electron microscope image 500 with the side surface of the electron microscope image 510, the structure wherein the first reinforcement layer is additionally formed on the radiative cooling layer can be confirmed.

As the highly-durable first reinforcing layer for radiative cooling is introduced, the surface becomes smooth.

In other words, the present invention may improve surface roughness while maintaining radiative cooling performance without deteriorating radiative cooling performance and while improving durability and anti-fouling properties by introducing the reinforcement layer for radiative cooling.

FIG. 6 is a drawing for explaining a method of manufacturing a radiative cooling device including a second reinforcement layer for radiative cooling according to an embodiment of the present invention.

FIG. 6 illustrates the method of manufacturing the radiative cooling device including the second reinforcement layer for radiative cooling according to an embodiment of the present invention.

Referring to FIG. 6, to form a second reinforcement layer for improving a water contact angle and for radiative cooling, a hydrophobic spray device 610 sprays a solution, prepared by dispersing at least one fluorosilane-based material in a solvent and contained in a container 611, on a radiative cooling device 600 coated with a colored radiative cooling paint, thereby coating a second reinforcement layer.

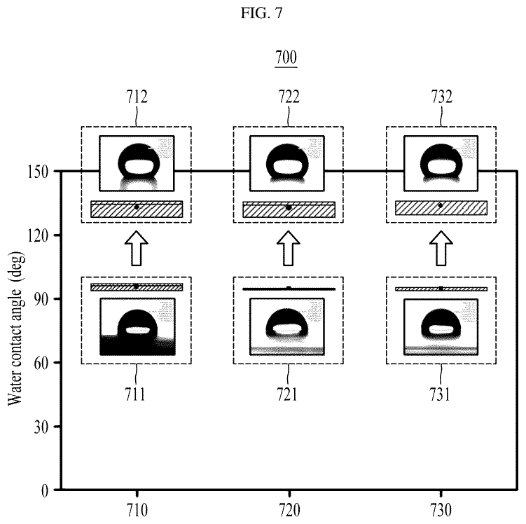

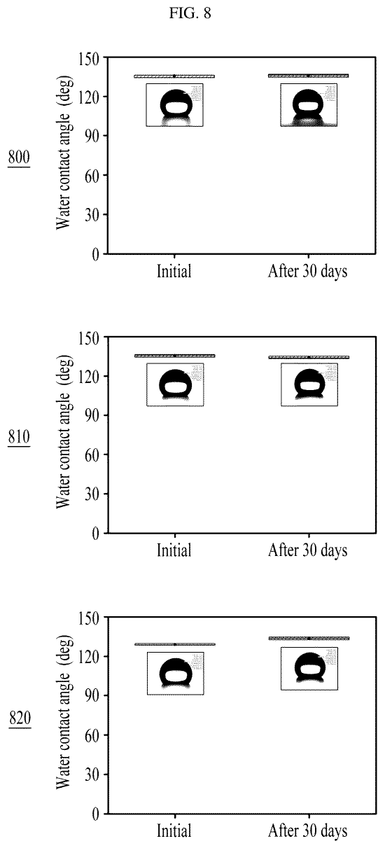

FIGS. 7 and 8 are drawings for explaining changes in the water contact angle of the radiative cooling device including the second reinforcement layer for radiative cooling according to an embodiment of the present invention.

FIG. 7 illustrates increased changes in the water contact angle of the radiative cooling device including the second reinforcement layer for radiative cooling according to an embodiment of the present invention.

Referring to FIG. 7 in relation to the water contact angle (static contact angle), a graph 700 shows a red sample 710 in which a red-implementing layer was formed on a radiative cooling layer, and then a second reinforcement layer was formed thereon; an orange sample 720 in which an orange-implementing layer was formed on a radiative cooling layer, and then a second reinforcement layer was formed thereon; and a yellow sample 730 in which a yellow-implementing layer was formed on a radiative cooling layer, and then a second reinforcement layer was formed thereon.

The red sample 710 shows a change in the water contact angle between a sample 711 before the creation of the second reinforcement layer and a sample 712 after the creation of the second reinforcement layer.

The orange sample 720 shows a change in the water contact angle between a sample 721 before the creation of the second reinforcement layer and a sample 722 after the creation of the second reinforcement layer.

The yellow sample 730 shows a change in the water contact angle between a sample 731 before the creation of the second reinforcement layer and a sample 732 after the creation of the second reinforcement layer.

From the graph 700, it can be confirmed that when the second reinforcement layer for enhancing a water contact angle is formed on the radiative cooling layer, the water contact angle significantly increases from 90 degrees to 120 degrees or more.

FIG. 8 illustrates a change over time in the water contact angle of the radiative cooling device including the second reinforcement layer for radiative cooling according to an embodiment of the present invention.

Referring to FIG. 8, a graph 800 illustrates a change in the water contact angle of the red sample in its initial state and after 30 days, a graph 810 illustrates a change in the water contact angle of the orange sample in its initial state and after 30 days, and a graph 820 illustrates a change in the water contact angle of the yellow sample in its initial state and after 30 days.

The graphs 800 to 820 show that the improved water contact angle is well maintained at 120 degrees or more even after 30 days.

The second reinforcement layer may increase the contact angle from 90 degrees to 120 degrees or more, maintain the increased 120 degrees for more than a certain time, achieve hydrophobicity based on the increased 120 degrees, and maintain the achieved radiative cooling emissivity and the achieved radiative cooling reflectivity.

In other words, the second reinforcement layer may increase durability and anti-fouling properties by repelling contaminants against the surface based on the increased water contact angle while maintaining the radiative cooling performance of the radiative cooling layer.

Therefore, the present invention forms a reinforcement layer for radiative cooling to increase the water contact angle and to reduce the degree of contamination from contaminants as water bounces, thereby preserving long-term optical characteristics.

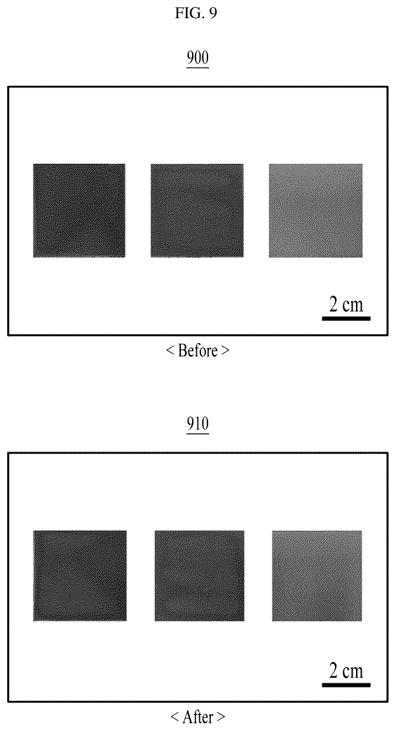

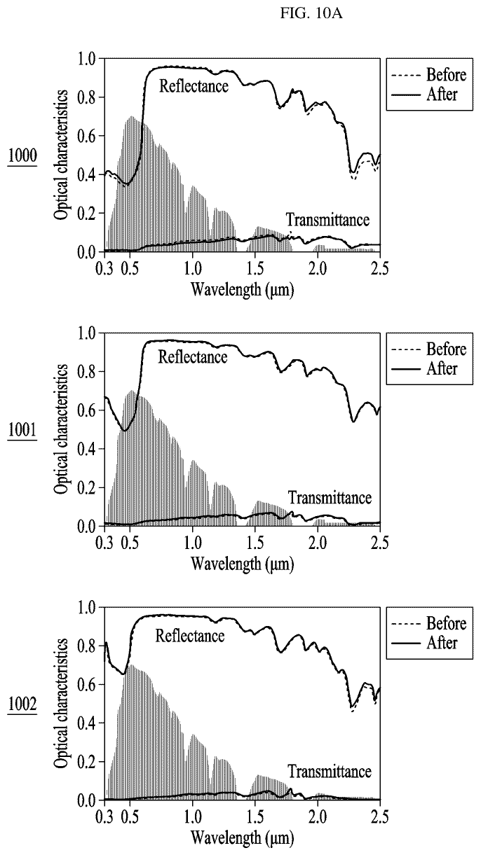

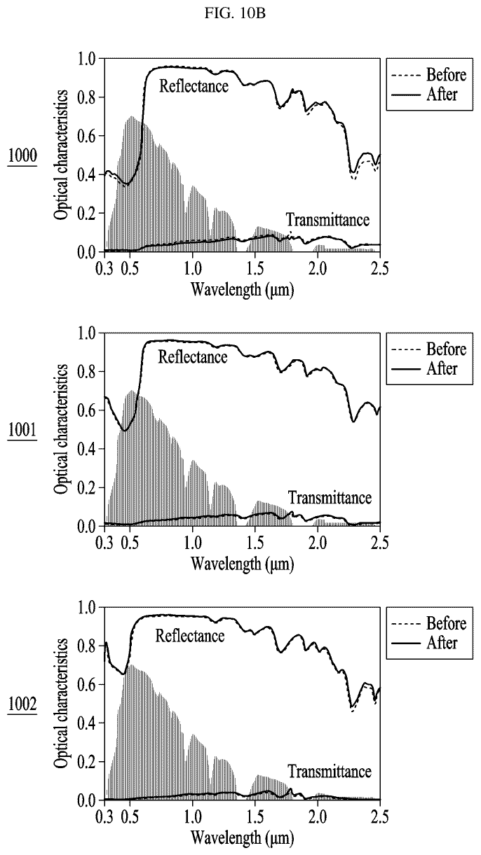

FIGS. 9 to 10B are drawings for explaining the optical characteristics of the radiative cooling device including the second reinforcement layer for radiative cooling according to an embodiment of the present invention.

FIG. 9 illustrates images before and after the formation of the radiative cooling device including the second reinforcement layer for radiative cooling according to an embodiment of the present invention.

In FIG. 9, an image 900 is an image before the formation of the radiative cooling device including the second reinforcement layer for radiative cooling according to an embodiment of the present invention, and an image 901 is an image after the formation of the radiative cooling device including the second reinforcement layer for radiative cooling.

When comparing the image 900 with the image 901, it can be seen that the images are similar in appearance, and a color-implementing layer is added on the radiative cooling layer, so the colors of red, orange and yellow can be similarly implemented.

The image 900 illustrates a sample wherein a radiative cooling paint composed of ceramic particles of Al₂O₃ and SiO₂, particles of a urethane polymer and a binder is formed as a radiative cooling layer with a thickness of 250 μm, and a color-implementing layer based on a colored fluorescent paint is coated to a thickness of 30 μm thereon.

The image 901 illustrates a sample wherein the second reinforcement layer is additionally formed on a sample corresponding to the image 900.

Comparing the image 900 with the image 901, it is difficult to see the difference.

FIG. 10A illustrates the reflectance and transmittance experimental results of the samples of the images 900 and 901 shown in FIG. 9.

FIG. 10B illustrates the results of atmospheric window emissivity experiments for the samples of the images 900 and 901 shown in FIG. 9.

Referring to FIGS. 10A and 10B, the optical characteristics of the radiative cooling device including the second reinforcement layer for radiative cooling according to each of graphs 1000 to 1002 and graphs 1010 to 1012 are summarized in Table 2.

The graphs 1000 and 1010 show the red sample (red-colored RC), the graphs 1001 and 1011 show the orange sample (orange-colored RC), and the graphs 1002 and 1012 show the yellow sample (yellow-colored RC).

The graphs 1000 to 1002 show a reflectance and a transmittance, and the graphs 1010 to 1012 show an absorptivity and an emissivity.

TABLE 2

| | Red | | Orange | | Yellow | |
|---|---|---|---|---|---|---|
| | Before | After | Before | After | Before | After |
| Rₛₒₗₐᵣ | 74.3% | 74.5% | 81.0% | 81.0% | 88.8% | 88.5% |
| (0.3-2.5 μm) | | | | | | |
| Tₛₒₗₐᵣ | 3.5% | 2.9% | 2.8% | 3.0% | 2.5% | 2.3% |
| (0.3-2.5 μm) | | | | | | |
| A_{sola r} | 22.2% | 22.6% | 16.2% | 16.0% | 8.6% | 9.2% |
| (0.3-2.5 μm) | | | | | | |
| R_{NIR} | 91.1% | 90.9% | 91.9% | 92.0% | 92.5% | 92.3% |
| (0.3-2.5 μm) | | | | | | |
| T_{NIR} | 5.2% | 4.4% | 4.0% | 4.3% | 3.4% | 3.1% |
| (0.3-2.5 μm) | | | | | | |
| A_{NIR} | 3.6% | 4.7% | 4.1% | 3.7% | 4.1% | 4.6% |
| (0.3-2.5 μm) | | | | | | |
| εLWIR | 93.6% | 94.1% | 93.6% | 93.6% | 93.9% | 93.7% |
| (8-13 μm) | | | | | | |

Referring to Table 2, it is difficult to confirm changes in the reflectances (R), transmittances (T) and absorptivity (A) before and after the formation in a wavelength range of 0.3 μm to 2.5 μm (solar) and a wavelength range of 0.3 μm to 2.5 μm (near infrared ray, NIR) in all of the red, orange and yellow samples.

In a wavelength range of 8 μm to 13 μm, it is difficult to confirm changes in the atmospheric window emissivity (ε_{LWIR}) before and after the formation in all of the red, orange and yellow samples.

It is difficult to confirm a decrease in the radiative cooling performance of the radiative cooling device due to the additional formation of the second reinforcement layer.

Therefore, the present invention may improve the durability and contamination prevention properties of a radiative cooling device including radiative cooling paint which can be installed outdoors in data centers, communication equipment, relay facilities, etc. and can be used as a method to solve problems caused by temperature increase of equipment due to internal heat.

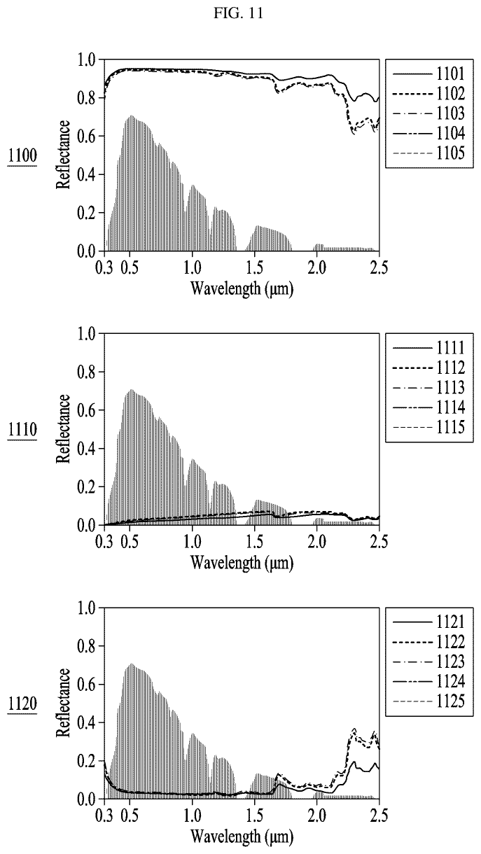

FIG. 11 is a set of drawings for explaining the formation ratios of the reinforcement layer for radiative cooling and radiative cooling layer according to an embodiment of the present invention.

FIG. 11 illustrates the formation ratios of the reinforcement layer for radiative cooling and radiative cooling layer according to an embodiment of the present invention, and the optical characteristics of the radiative cooling device dependent upon the formation ratios.

Referring to FIG. 11, a graph 1100 represents a reflectance, a graph 1110 represents a transmittance, and a graph 1120 represents an absorptivity.

In the graphs 1100 to 1120, the first to fifth samples are compared.

The first sample may represent the case where the radiative cooling layer is formed to a thickness of 148 μm, and the second sample may represent the case where the radiative cooling layer is formed to a thickness of 140 μm, and then the reinforcement layer is formed to a thickness of 90 μm.

The third sample may represent the case where the radiative cooling layer is formed to a thickness of 136 μm, and then the reinforcement layer is formed to a thickness of 88 μm, and the fourth sample may represent the case where a radiative cooling layer is formed to a thickness of 136 μm, and then the reinforcement layer is formed to a thickness of 92 μm.

The fifth sample may represent the case where the radiative cooling layer is formed to a thickness of 132 μm, and then the reinforcement layer is formed to a thickness of 91 μm, and the reinforcement layer may be a first reinforcement layer for increasing durability.

The atmospheric window radiation of each sample was additionally measured along with the optical characteristics and formation ratios of the reinforcement layers for radiative cooling and the radiative cooling layers according to the graphs 1100 to 1120, and the cooling power dependent upon the radiative cooling performance is summarized in Table 3.

TABLE 3

| | First | Second | Third | Fourth | Fifth | |
|---|---|---|---|---|---|---|
| | sample | sample | sample | sample | sample | Average |
| Radiative cooling | 148 | 140 | 136 | 136 | 132 | 136 |
| layer thickness (μm) | | | | | | |
| Thickness (μm) after | 148 | 230 | 224 | 228 | 223 | 226 |
| formation | | | | | | |
| Contrast ratio (%) | 0 | 64 | 65 | 67 | 69 | 66 |
| Sunlight reflection | 94.1 | 92.7 | 92.4 | 93.0 | 92.8 | 92.7 |
| (%) | | | | | | |
| Sunlight transmission | 2.3 | 3.5 | 3.3 | 3.8 | 3.7 | 3.6 |
| (%) | | | | | | |
| Sunlight absorption | 3.6 | 3.8 | 4.3 | 3.2 | 3.5 | 3.7 |
| (%) | | | | | | |
| Atmospheric window | 89.0 | 93.8 | 94.0 | 94.0 | 94.0 | 93.9 |
| radiation (%) | | | | | | |
| Total cooling power | 95.3 | 97.6 | 93.1 | 102.8 | 100.6 | 98.5 |
| (W/m²) | | | | | | |

The graph 1100 shows a first sample 1101, a second sample 1102, a third sample 1103, a fourth sample 1104 and a fifth sample 1105.

The graph 1110 shows a first sample 1111, a second sample 1112, a third sample 1113, a fourth sample 1114 and a fifth sample 1115.

The graph 1120 shows a first sample 1121, a second sample 1122, a third sample 1123, a fourth sample 1124 and a fifth sample 1125.

Referring to Table 3, it can be confirmed that cooling performance is improved due to an increase in atmospheric window radiation and a slight change in performance in a wavelength range corresponding to incident sunlight.

According to an embodiment of the present invention, the thickness of the first reinforcement layer may be formed in a ratio of 70% or less compared to the thickness of the radiative cooling layer.

As the thickness of the first reinforcement layer increases, the durability is improved, but the radiative cooling performance may deteriorate. As the thickness of the first reinforcement layer decreases, the radiative cooling performance is maintained, but it is difficult to expect an improvement in durability.

For example, the thickness of the first reinforcement layer may be formed in a ratio of 10% to 70% compared to the thickness of the radiative cooling layer.

More preferably, the thickness of the first reinforcement layer may be formed in a ratio of 64% to 69% compared to the thickness of the radiative cooling layer according to an embodiment of the present invention.

That is, the radiative cooling device according to an embodiment of the present invention may improve the durability of the radiative cooling device while maintaining or improving the radiative cooling performance based on the first reinforcement layer formed at 64% to 69% relative to the thickness of the radiative cooling layer.

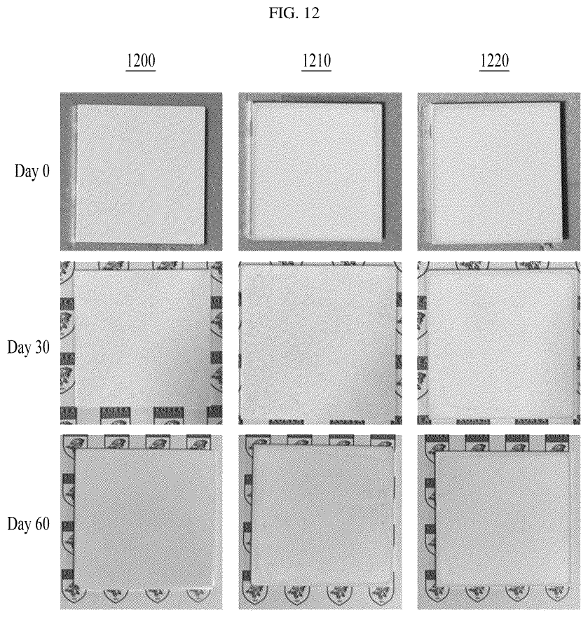

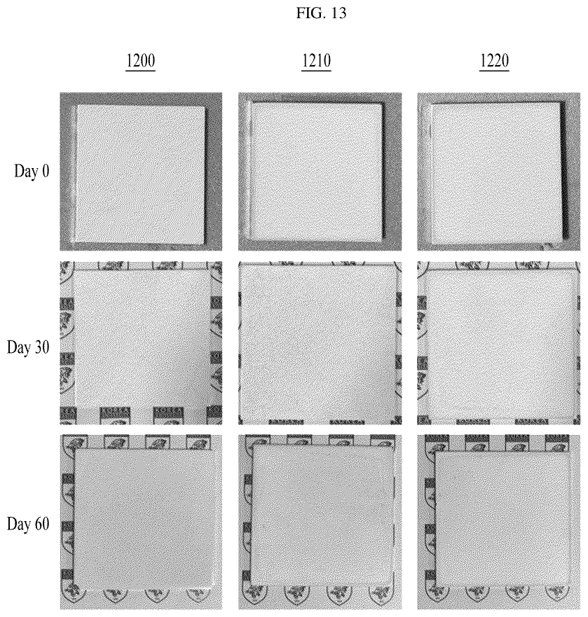

FIGS. 12 and 13 are drawings for explaining the performance of the radiative cooling device dependent upon the formation of the reinforcement layer for radiative cooling according to an embodiment of the present invention.

FIG. 12 illustrates sample photographs related to the performance of the radiative cooling device dependent upon the formation of the reinforcement layer for radiative cooling according to an embodiment of the present invention.

Referring to FIG. 12, an image 1200 shows a commercialized white paint, an image 1210 shows a radiative cooling paint, and an image 1220 shows a radiative cooling paint including a reinforcement layer formed thereon.

When comparing the images 1200, 1210 and 1220, there is little difference in color.

FIG. 13 illustrates optical characteristics corresponding to the images 1200, 1210 and 1220 in relation to the performance of the radiative cooling device dependent upon the formation of the reinforcement layer for radiative cooling according to an embodiment of the present invention.

Referring to FIG. 13, a graph 1300 relates a reflectance measured at day 0, an indicator line 1301 represents the reflectance of a commercialized white paint, an indicator line 1302 represents the reflectance of a radiative cooling paint, and an indicator line 1303 represents the reflectance of a radiative cooling paint including a reinforcement layer formed thereon.

Data of the graph 1300 is summarized in Table 4 below.

TABLE 4

| | | | Radiative cooling |
|---|---|---|---|
| | | Radiative | paint including |
| | Commercialized | cooling | reinforcement layer |
| Day 0 | white paint | paint | formed thereon |
| Reflectance (%) | 81.55 | 95.86 | 95.96 |
| Absorptivity (%) | 18.45 | 4.14 | 4.04 |
| Emissivity (%) | 90.38 | 92.04 | 87.64 |
| Cooling power | −36.41 | 92.16 | 86.33 |
| (W/m²) | | | |

A graph 1310 relates a reflectance measured at day 30, an indicator line 1311 represents the reflectance of a commercialized white paint, an indicator line 1312 represents the reflectance of a radiative cooling paint, and an indicator line 1313 represents the reflectance of a radiative cooling paint including a reinforcement layer formed thereon.

Data of the graph 1310 is summarized in Table 5 below.

TABLE 5

| | | | Radiative cooling |
|---|---|---|---|
| | | | paint including |
| | Commercialized | Radiative | reinforcement layer |
| Day 30 | white paint | cooling paint | formed thereon |
| Reflectance (%) | 78.86 | 92.14 | 93.18 |
| Absorptivity (%) | 21.14 | 7.86 | 6.82 |
| Emissivity (%) | 90.68 | 91.32 | 87.61 |
| Cooling power | −59.70 | 58.08 | 61.50 |
| (W/m²) | | | |

A graph 1320 relates a reflectance measured at day 60, an indicator line 1321 represents the reflectance of a commercialized white paint, an indicator line 1322 represents the reflectance of a radiative cooling paint, and an indicator line 1323 represents the reflectance of a radiative cooling paint including a reinforcement layer formed thereon.

Data of the graph 1320 is summarized in Table 6 below.

TABLE 6

| | | | Radiative cooling |
|---|---|---|---|
| | | Radiative | paint including |
| | Commercialized | cooling | reinforcement layer |
| Day 60 | white paint | paint | formed thereon |
| Reflectance (%) | 78.14 | 89.71 | 92.69 |
| Absorptivity (%) | 21.86 | 10.29 | 7.31 |
| Emissivity (%) | 90.20 | 91.06 | 87.36 |
| Cooling power | −65.84 | 37.00 | 57.58 |
| (W/m²) | | | |

Referring to the graphs 1300 to 1320, it can be confirmed that the radiative cooling device according to an embodiment of the present invention created with the radiative cooling paint corresponding to a sample in which the reinforcement layer corresponding to a top coat is formed exhibits lower performance degradation than samples according to existing technologies.

In the aforementioned embodiments, constituents of the present invention were expressed in a singular or plural form depending upon embodiments thereof.

However, the singular or plural expressions should be understood to be suitably selected depending upon a suggested situation for convenience of description, and the aforementioned embodiments should be understood not to be limited to the disclosed singular or plural forms. In other words, it should be understood that plural constituents may be a singular constituent or a singular constituent may be plural constituents.

While the embodiments of the present invention have been described, those skilled in the art will appreciate that many modifications and changes can be made to the present invention without departing from the spirit and essential characteristics of the present invention.

Therefore, it should be understood that there is no intent to limit the invention to the embodiments disclosed, rather, the invention is to cover all modifications, equivalents, and alternatives falling within the spirit and scope of the invention as defined by the claims.

1. A radiative cooling device, comprising:
a radiative cooling layer formed of a first mixture prepared by mixing at least one particle of pores, ceramic particles and polymer particles with a binder, formed on a substrate, configured to absorb and emit long-wavelength infrared rays in a range of 8 μm to 13 μm based on the first mixture to achieve radiative cooling emissivity, and configured to scatter and reflect incident sunlight in a range of 0.3 μm to 2.5 μm to achieve radiative cooling reflectivity;
a first reinforcement layer formed on the radiative cooling layer, formed of a second mixture of ceramic particles and a binder, configured to prevent mass loss due to external exposure or friction based on the second mixture to increase the durability of the radiative cooling layer, configured to increase the radiative cooling emissivity, and configured to maintain the radiative cooling reflectivity; and
a second reinforcement layer formed on the first reinforcement layer or the radiative cooling layer, formed of at least one fluorosilane-based material, and configured to increase a contact angle for a liquid material in contact with a surface.

2. The radiative cooling device according to claim 1, wherein the radiative cooling layer absorbs and emits the long-wavelength infrared rays, supplements absorption and emission of long-wavelength infrared rays of the binder to increase emissivity in the long-wavelength infrared ray range of 8 μm to 13 μm, and additionally scatters and reflects the incident sunlight based on a difference in refractive indices of the binder and the pores.

3. The radiative cooling device according to claim 2, wherein the ceramic particles comprised in the first mixture comprise at least one of TiO₂, Al₂O₃, h-BN, ZrO₂, SiO₂, CaCO₃, CaCO₄, BaSO₄, Y₂O₃, Ta₂O₅, Si₃N₄, BeO, MgHPO₄, ZnO, SiC, AlPO₄, AlN and YSZ,
the polymer particles comprised in the first mixture comprise at least one of DiPentaerythritol HexaAcrylate (DPHA), PolyDiMethylSiloane (PDMS), Ethylene Tetra Fluoro Ethylene (ETFE), PUA, PolyVinyliDene Fluoride (PVDF), PolyChloroTriFluoroEthylene (PCTFE), PolyEthylene Terephthalate (PET), PolyCarbonate (PC), PolyStyrene (PS) and polyethylene oxide, and
the binder comprised in the first mixture comprises at least one of DPHA, PDMS, ETFE, PUA, PVDF, PCTFE, PET, PC, PS, polyethylene oxide, a polyester-based polymer, a polyurethane-based polymer, an acrylic polymer and an alkyd-based polymer.

4. The radiative cooling device according to claim 1, wherein the ceramic particles comprised in the second mixture comprise at least one of TiO₂, Al₂O₃, h-BN, ZrO₂, SiO₂, CaCO₃, CaCO₄, BaSO₄, Y₂O₃, Ta₂O₅, Si₃N₄, BeO, MgHPO₄, ZnO, SiC, AlPO₄, AlN and YSZ, and
the binder comprised in the second mixture comprises at least one of DPHA, PDMS, ETFE, PUA, PVDF, PCTFE, PET, PC, PS, polyethylene oxide, a polyester-based polymer, a polyurethane-based polymer, an acrylic polymer and an alkyd-based polymer.

5. The radiative cooling device according to claim 4, wherein a thickness of the first reinforcement layer is formed in a ratio of 70% or less compared to a thickness of the radiative cooling layer.

6. The radiative cooling device according to claim 4, wherein the first reinforcement layer is formed by applying a solution, prepared by mixing the second mixture with a solvent, in one coating method of spin coating, bar coating, spray coating, doctor blading, blade coating and dipping.

7. The radiative cooling device according to claim 1, wherein the fluorosilane-based material comprises at least one of 1H,1H,2H,2H-(Perfluorooctyltriethoxysilane) (PFOES) and Heptadecafluoro-1,1,2,2-tetrahydrodecyl) trichlorosilane (HDFS).

8. The radiative cooling device according to claim 7, wherein the second reinforcement layer is formed by applying a solution, prepared by dispersing the fluorosilane-based material in a solvent, in one coating method of spin coating, bar coating, spray coating, doctor blading, blade coating and dipping.

9. The radiative cooling device according to claim 1, wherein the second reinforcement layer increases the contact angle from 90 degrees to 120 degrees or more, maintains the increased 120 degrees for a predetermined time, achieves hydrophobicity based on the increased 120 degrees, and maintains the achieved radiative cooling emissivity and the achieved radiative cooling.

10. The radiative cooling device according to claim 1, wherein the radiative cooling layer further comprises a color implementation layer for implementing a color according to a type of color paint formed thereon.
